(19) United States
(12) Patent Application Publication
(10) Pub. No.: US 2026/0243887 A1
(43) Pub. Date: Aug. 20, 2026

(54) TIME-SERIES INSAR METHOD FOR MONITORING MULTI-DIMENSIONAL DEFORMATION OF LANDSLIDE

(71) Applicant: SouthWest Petroleum University, Chengdu (CN)

(72) Inventors: Bing Yu, Chengdu (CN); Hengchong Liu, Chengdu (CN); Junnan Guan, Chengdu (CN); Peng Yang, Chengdu (CN); Jie Zhang, Chengdu (CN); Jiyan Wang, Chengdu (CN); Jiawei Yang, Chengdu (CN); Lei Wang, Chengdu (CN); Deying Ma, Chengdu (CN); Lizhang Fan, Chengdu (CN)

(21) Appl. No.: 19/373,771

(22) Filed: Oct. 30, 2025

(30) Foreign Application Priority Data
Feb. 17, 2025 (CN) 202510168657.7

(51) Int. Cl. G01S 13/90; G01S 13/72

(52) U.S. Cl. CPC G01S 13/9023; G01S 13/72; G01S 13/9017; G01S 13/9094

(57) ABSTRACT

A time-series InSAR method for monitoring multi-dimensional deformation of a landslide includes the following steps: firstly, obtaining a deformation observation of a target landslide in a line-of-sight direction; and subsequently inputting the deformation observation into a monitoring model with a fractal composite structure deformation constraint model to thereby obtain deformation time series of a sliding mass in vertical, east-west, downslope, and perpendicular-to-downslope directions. This method can simultaneously obtain characteristics of the deformation time series of the sliding mass along four dimensions, namely the vertical, east-west, downslope, and perpendicular-to-downslope directions. A model constructed by the method covers linear, acceleration, periodicity, high frequency, and thermal expansion deformation, fully considering complexity of landslide deformation and having strong adaptability. Moreover, the model emphasizes differences in deformations between the vertical and east-west directions, and between the downslope and perpendicular-to-downslope directions, and constructs different constraint conditions to form independent deformation model constraints.

### CROSS-REFERENCE TO RELATED APPLICATION

This application claims priority to Chinese Patent Application No. 202510168657.7, filed on Feb. 17, 2025, which is herein incorporated by reference in its entirety.

### TECHNICAL FIELD

The disclosure relates to the technical field of data processing, and more particularly to a time-series interferometric synthetic aperture radar (InSAR) method for monitoring multi-dimensional deformation of a landslide.

### BACKGROUND

A landslide refers to an adverse geological phenomenon that part or all of soil and rock mass slides downward as a whole along a weak surface or weak zone of a slope under action of gravity. Landslide disaster is a combination of all kinds of landslides, collapses, and debris flows, which is mainly caused by earthquakes, volcanic activity, river erosion, freeze-thaw cycles, precipitation, and human activities. It is of great practical significance to identify potential landslide sites in landslide-prone areas in advance. One of important characteristics of the potential landslide sites is instability of the slope, which will cause displacement in space, namely, surface deformation. Therefore, landslide deformation monitoring should be carried out in the landslide-prone areas, unstable mountain slope can be located according to deformation measurement results, and risk levels of the landslides can be classified according to deformation rates. Additionally, based on the deformation measurement results in time series, a deformation prediction model can be constructed to predict an evolution trend of slope deformation with time, which provides more abundant and detailed reference information for identifying the potential landslide sites and classifying the risk levels of the landslides. Among them, accurately extracting real deformation of a slope space is a most critical process.

In an aspect of the landslide deformation monitoring, a time-series InSAR measurement method has shown great technological advantages and potential, has advantages of high spatial resolution, high efficiency, low cost, and strong adaptability, and can avoid safety accidents that may occur during on-site measurement. However, since an InSAR technology extracts deformation by interfering with data obtained by a side-looking synthetic aperture radar (SAR) sensor, and the side-looking SAR sensor can only detect one-dimensional information along an observation direction. Therefore, time-series InSAR technologies in the art can only obtain a single displacement component of landslide deformation along a line-of-sight direction of a radar, but cannot obtain real deformation information of the landslide.

In an aspect of deformation monitoring technology for the landslide in different dimensions, technologies in the art are mostly based on InSAR data from different orbits or platforms to construct observation equations through an intersection principle to thereby calculate static two-dimensional deformation rates, such as static deformation rates in vertical and east-west directions, downslope and vertical directions, and downslope and perpendicular-to-downslope directions. However, the static two-dimensional deformation rates cannot trace back time-series deformation characteristics of the landslide, which makes deformation information of the landslide incomplete and affects subsequent analysis and evaluation. For landslides with significant deformation, time-series pixel offset tracking (POT) or time-series POT combined with time-series InSAR can obtain two-dimensional deformation time series in vertical and horizontal directions. However, POT technology extracts the deformation information by obtaining pixel offsets of different SAR image pairs. Due to large errors corresponding to the pixel offsets, an accuracy of deformation monitoring is low, with an error of more than 5 centimeters (cm). Therefore, the POT technology is only suitable for large-scale deformations, such as deformations of 50 cm per year or more. However, time-series deformations of general landslides are each only 5 to 20 cm per year, so the time-series POT is not applicable. Moreover, because the pixel offsets of different SAR image pairs only correspond to the horizontal direction, this technology can only monitor deformation in the horizontal direction, but cannot monitor deformations in the vertical, downslope, and perpendicular-to-downslope directions. In an aspect of monitoring technologies for multi-dimensional time-series deformation, multi-dimensional short baseline subset (MSBAS) interferometric deformation monitoring technology constructs a two-dimensional time-series deformation monitoring model based on ascending and descending orbit time-series InSAR results and regularization constraints, which can be applied to time-series two-dimensional deformation monitoring of the landslide and obtain two-dimensional deformation time series of the landslide in the vertical and east-west directions. However, characteristics of the landslide deformation are mainly manifested as sliding along the downslope direction and sliding along the perpendicular-to-downslope direction. MSBAS technology can only obtain the two-dimensional deformation time series of the landslide in the vertical and east-west directions, and cannot obtain true time-series deformation characteristics of the landslide along the downslope direction and the perpendicular-to-downslope direction. In addition, this technology does not consider thermal expansion and cold contraction deformation of a monitoring target and a physical mechanism of deformation, which affects the accuracy of deformation monitoring.

### SUMMARY

To overcome the aforementioned deficiencies, the disclosure provides a technical solution that can solve or at least partially solve a problem that real deformation characteristics of a landslide in a downslope direction and a perpendicular-to-downslope direction cannot be obtained.

A time-series InSAR method for monitoring multi-dimensional deformation of the landslide provided by the disclosure includes: obtaining a deformation observation of a target landside (also referred to as a sliding mass) in a line-of-sight direction; inputting the deformation observation of the target landslide in the line-of-sight direction into a monitoring model to obtain deformation time series of the sliding mass in a vertical direction, an east-west direction, the downslope direction, and the perpendicular-to-downslope direction, in which the monitoring model at least includes a fractal composite structure deformation constraint model; constraining vertical deformation and east-west deformation of the based on a first constraint condition constructed by the fractal composite structure deformation constraint model; and constraining downslope deformation and perpendicular-to-downslope deformation based on a second constraint condition constructed by the fractal composite structure deformation constraint model.

In an embodiment, based on the deformation time series of the sliding mass in the vertical direction, the east-west direction, the downslope direction, and the perpendicular-to-downslope direction, a three-dimensional landslide model can be generated by software to show dynamical evolution of the sliding mass, and the three-dimensional landslide model can be displayed on a display screen to present related personnels with a displacement trajectory and characteristics of the sliding mass. Based on the displacement trajectory and characteristics of the sliding mass, the related personnels can take measures to avoid occurrence of landslide disaster, including constructing dendritic intercepting ditches with a main drainage ditch aligned with a movement direction of the sliding mass and branch ditches constructed at 30 degrees (°) to 45° oblique angles to the downslope direction on a surface of the sliding mass to divert surface water into natural gullies; constructing retaining walls with masonry stone, concrete, or reinforced concrete at a toe of the sliding mass to prevent local collapse at the toe of the sliding mass and avoid progressive deterioration of slope stability; and driving anti-slide piles into the sliding mass to anchor the sliding mass and enhance overall stability of the sliding mass.

In an embodiment, the time-series InSAR method for monitoring the multi-dimensional deformation of the landslide further includes: based on the deformation time series of the sliding mass in the vertical direction, the east-west direction, the downslope direction, and the perpendicular-to-downslope direction, determining, by a processor, a displacement trajectory of the sliding mass; and installing, by a drill rig and based on the displacement trajectory of the sliding mass, anti-slide piles and anchor cables along the displacement trajectory on the sliding mass to enhance safety and stability of the sliding mass.

In an embodiment, the time-series InSAR method for monitoring the multi-dimensional deformation of the landslide further includes: based on the deformation time series of the sliding mass in the vertical direction, the east-west direction, the downslope direction, and the perpendicular-to-downslope direction, determining, by a processor, a displacement trajectory of the sliding mass; superposing the displacement trajectory of the sliding mass onto a satellite image map to obtain a superposed image map; and displaying the superposed image map on a display screen; the superposed image map is configured to present information associated with the sliding mass, which makes related personnel aware of the displacement trajectory of the sliding mass, thereby allowing the related personnel to take necessary response measures including sending landslide early warning to people and evacuating the people.

In an embodiment of the time-series InSAR method for monitoring the multi-dimensional deformation of the landslide, the fractal composite structure deformation constraint model includes a first constraint model and a second constraint model. The first constraint model is a constraint model for time-series deformations in the vertical direction and the and east-west direction. The second constraint model is a constraint model for time-series deformations in the downslope direction and the perpendicular-to-downslope direction. The time-series InSAR method further includes: constructing the fractal composite structure deformation constraint model, which at least includes: constructing the first constraint model and the second constraint model by fully combining mathematical models of surface deformations in different types of regions.

In an embodiment of the time-series InSAR method for monitoring the multi-dimensional deformation of the landslide, the constructing the first constraint model and the second constraint model by fully combining mathematical models of surface deformation in different types of regions at least includes: obtaining first parameters of the fractal composite structure deformation constraint model, in which the first parameters include: the vertical deformation and the east-west deformation corresponding to an m-th moment, parameters of a constraint model for the vertical deformation, parameters of a constraint model for the east-west deformation, an acquisition time of a first SAR image, an acquisition time of an m-th SAR image, thermal expansion deformation coefficients in the vertical direction and the east-west direction, and a temperature difference between the acquisition time of the m-th SAR image and an initial time; constructing the first constraint model based on the first parameters; obtaining second parameters of the fractal composite structure deformation constraint model, in which the second parameters include: the downslope deformation and the perpendicular-to-downslope deformation corresponding to the m-th moment, parameters of a constraint model for the downslope deformation, parameters of a constraint model for the perpendicular-to-downslope deformation, the acquisition time of the first SAR image, the acquisition time of the m-th SAR image, thermal expansion deformation coefficients in the downslope direction and the perpendicular-to-downslope direction, and the temperature difference between the acquisition time of the m-th SAR image and the initial time; and constructing the second constraint model based on the second parameters.

In an embodiment of the time-series InSAR method for monitoring the multi-dimensional deformation of the landslide, the monitoring model further includes a first observation equation and a second observation equation. The inputting the deformation observation of the target landslide in the line-of-sight direction into a monitoring model to obtain deformation time series of the sliding mass in a vertical direction, an east-west direction, a downslope direction, and a perpendicular-to-downslope direction at least includes: constraining the vertical deformation and the east-west deformation based on the first constraint model to thereby construct the first observation equation with independent constraint conditions respectively for the constraint model for the vertical deformation and the constraint model for the east-west deformation; constraining the downslope deformation and the perpendicular-to-downslope deformation based on the second constraint model to thereby construct the second observation equation with independent constraint conditions respectively for the constraint model for the downslope deformation and the constraint model for the perpendicular-to-downslope deformation; calculating the time-series deformation of the sliding mass in the vertical direction and the east-west direction based on the first observation equation; and calculating the time-series deformation of the sliding mass in the downslope direction and the perpendicular-to-downslope direction based on the second observation equation.

In an embodiment of the time-series InSAR method for monitoring the multi-dimensional deformation of the landslide, the inputting the deformation observation of the target landslide in the line-of-sight direction into a monitoring model to obtain deformation time series of the sliding mass in a vertical direction, an east-west direction, a downslope direction, and a perpendicular-to-downslope direction further includes: obtaining the deformation time series in the vertical direction and the east-west direction through integration of a time dimension based on the time-series deformations in the vertical direction and the east-west direction; obtaining the deformation time series in the downslope direction and the perpendicular-to-downslope direction through the integration of the time dimension based on the time-series deformations in the downslope direction and the perpendicular-to-downslope direction; assigning weights to different platforms through a variance component estimation method, and refining the deformation time series step by step through an iteratively reweighted least squares.

Compared with the related art, the time-series InSAR method for monitoring the multi-dimensional deformation of the landslide provided by the disclosure has the following beneficial effects. The time-series InSAR method fully considers complexity of landslide deformation, and the fractal composite structure deformation constraint model constructed by the disclosure not only includes linear deformation (linear term), deformation acceleration (quadratic term), and periodic deformation (sine and cosine terms), but also considers high-frequency deformation (cubic term) and thermal expansion deformation, thereby having better adaptability to complex landslide deformation. At the same time, the fractal composite structure deformation constraint model considers differences between the vertical deformation and the east-west deformation, and applies different constraint models to the vertical deformation and the east-west deformation: constraining the vertical deformation and the east-west deformation respectively based on the fractal composite structure deformation constraint model, thereby better considering the differences between the vertical deformation and the east-west deformation and forming constraints for the vertical deformation and the east-west deformation respectively. The fractal composite structure deformation constraint model further considers differences between the downslope deformation and the perpendicular-to-downslope deformation and constrains the downslope deformation and the perpendicular-to-downslope deformation, respectively, thereby constructing mutually independent constraint conditions for deformation models. In this way, the time-series InSAR method is more in line with an actual situation and improves an accuracy of calculation results.

Furthermore, the fractal composite structure deformation constraint model used by the disclosure does not need to project the vertical deformation and the east-west deformation to the line-of-sight direction when constructing the constraint conditions, so a problem of angle selection can be avoided, and the accuracy and stability of the calculation results can be improved.

### BRIEF DESCRIPTION OF DRAWINGS

Disclosed content of the disclosure will become easier to understand with reference to attached drawings. It will be easily understood by those skilled in the art that these attached drawings are only for illustrative purposes and are not intended to limit a scope of protection of the disclosure. In addition, similar numerals in the attached drawings are used to represent similar components.

FIG. 1 illustrates a flowchart of main steps of a time-series InSAR method for monitoring multi-dimensional deformation of a landslide according to an embodiment of the disclosure.

FIG. 2 illustrates a schematic relationship diagram of a sliding surface coordinate system of the landslide relative to a spatial three-dimensional coordinate system.

FIG. 3 illustrates a schematic geometric relationship diagram of the sliding surface coordinate system relative to a “north-east-high” coordinate system.

### DETAILED DESCRIPTION OF EMBODIMENTS

Some embodiments of the disclosure are described below with reference to attached drawings. It should be understood by those skilled in the art that these embodiments are only used to explain technical principles of the disclosure and are not intended to limit a scope of protection of the disclosure.

### Embodiment 1

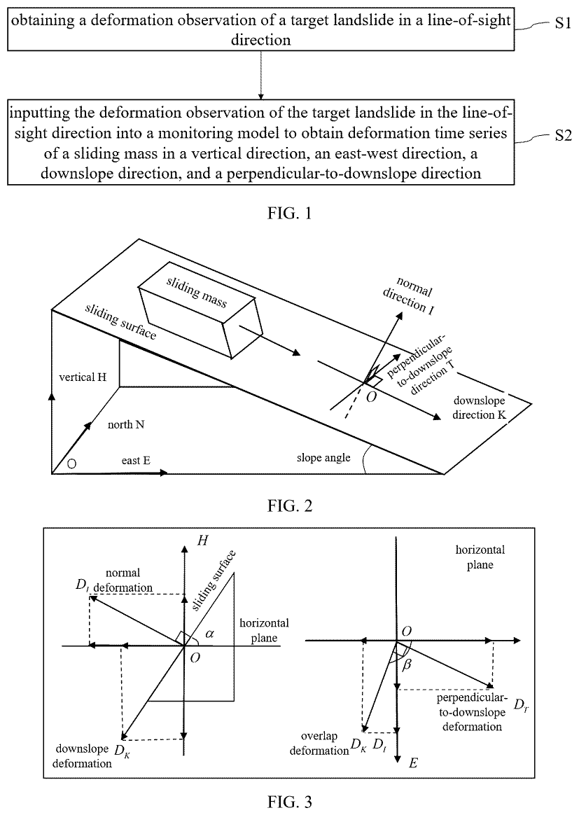

As illustrated in FIG. 1, a time-series InSAR method for monitoring multi-dimensional deformation of a landslide provided by the embodiment of the disclosure includes the following steps S1 through S2.

Step S1, a deformation observation of a target landslide in a line-of-sight direction is obtained.

Step S2, the deformation observation of the target landslide in the line-of-sight direction is input into a monitoring model to obtain deformation time series of a sliding mass in a vertical direction, an east-west direction, a downslope direction, and a perpendicular-to-downslope direction, in which the monitoring model at least includes a fractal composite structure deformation constraint model. Vertical deformation and east-west deformation is constrained based on a first constraint condition constructed by the fractal composite structure deformation constraint model. Downslope deformation and perpendicular-to-downslope deformation are constrained based on a second constraint condition constructed by the fractal composite structure deformation constraint model.

In the embodiment, the deformation observation can be deformation in the-line-of-sight direction monitored by SAR image data of different satellites and can also be deformation in the line-of-sight direction of a SAR satellite in a certain orbit at a specific moment in two different states of ascending orbit and descending orbit. The vertical direction refers to a direction vertical to a horizontal plane, and the east-west direction refers to a direction in the horizontal plane. Due to differences between the vertical deformation and the east-west deformation, different constraint models are applied to the vertical deformation and the east-west deformation. The vertical deformation and the east-west deformation are constrained respectively based on the fractal composite structure deformation constraint model, thereby better considering the differences between the vertical deformation and the east-west deformation and forming constraints for the vertical deformation and the east-west deformation respectively. The fractal composite structure deformation constraint model further considers differences between the downslope deformation and the perpendicular-to-downslope deformation and constrains the downslope deformation and the perpendicular-to-downslope deformation respectively, thereby constructing mutually independent constraint conditions for deformation models. In this way, the time-series InSAR method is more in line with an actual situation and improves an accuracy of calculation results.

In an embodiment, the fractal composite structure deformation constraint model includes a first constraint model and a second constraint model. The first constraint model is a constraint model for time-series deformations in the vertical direction and the and east-west direction. The second constraint model is a constraint model for time-series deformations in the downslope direction and the perpendicular-to-downslope direction. The time-series InSAR method further includes constructing the fractal composite structure deformation constraint model, which at least includes constructing the first constraint model and the second constraint model by fully combining mathematical models of surface deformations in different types of regions.

In the embodiment, the first constraint model is used to constrain the time-series deformations in the vertical direction and the east-west direction. The second constraint model is used to constrain the time-series deformations in the downslope direction and the perpendicular-to-downslope direction. Specifically, the mathematical models of surface deformations in different types of regions are shown in table 1. Physical meanings of parameters of the mathematical models shown in the table 1 are as follows: t represents a time relative to an initial time (namely an acquisition time of a first SAR image), v represents a rate of linear deformation, a represents a deformation acceleration, b represents a change of the deformation acceleration, A₁ and A₂ represent seasonal change intensities of a deformation respectively, T represents a period of trigonometric function models (such as 1 year), a represents a thermal expansion coefficient, and γ represents a temperature change value relative to the initial time.

TABLE 1

| Serial | Name of mathematical | Expression of | Physical |
|---|---|---|---|
| number | model | mathematical model | meaning |
| \textcircled{1} | linear term model | v · t | deformation rate |
| \textcircled{2} | quadratic term model | $\frac{1}{2} a \cdot {t}^{2}$ | change of deformation |
| | | | rate |
| \textcircled{3} | cubic term model | $\frac{1}{6} b \cdot {t}^{3}$ | change of acceleration |
| \textcircled{4} | sine model | A₁ · sin(2πt/T) | periodic |
| | | | deformation |
| \textcircled{5} | cosine model | A₂ · cos(2πt/T) | periodic |
| | | | deformation |
| \textcircled{6} | thermal expansion model | α · γ | thermal expan- |
| | | | sion and cold |
| | | | contraction |
| | | | deformation |
| | | | of a target |

Considering complexity of natural phenomena and processes, in order to ensure that a constructed deformation model has wider adaptability, constraint models for time-series deformations in the vertical direction and the and east-west direction are constructed respectively by fully combining the mathematical models shown in table 1, to thereby obtain the first constraint model.

Similarly, considering complexity of landslide deformation in a time dimension, a constraint model same as the first constraint model is used in calculation, and the second constraint model can be obtained based on this.

Specifically, an expression of the first constraint model is as follows:

$$\{ \begin{matrix}\begin{matrix}{d}_{m , U} = {a}_{0} + {a}_{1} ( {t}_{m} - {t}_{0} ) + \frac{1}{2} {{a}_{2} ( {t}_{m} - {t}_{0} )}^{2} + \\ \frac{1}{6} {a}_{3} {( {t}_{m} - {t}_{0} )}^{3} + {A}_{1} sin ( 2 π {t}_{m} / T ) + {A}_{2} cos ( 2 π {t}_{m} / T ) + {α}_{U} {γ}_{m}\end{matrix} \\ \begin{matrix}{d}_{m , E} = {b}_{0} + {b}_{1} ( {t}_{m} - {t}_{0} ) + \frac{1}{2} {{b}_{2} ( {t}_{m} - {t}_{0} )}^{2} + \\ \frac{1}{6} {b}_{3} {( {t}_{m} - {t}_{0} )}^{3} + {B}_{1} sin ( 2 π {t}_{m} / T ) + {B}_{2} cos ( 2 π {t}_{m} / T ) + {α}_{E} {γ}_{m}\end{matrix}\end{matrix} \qquad ( 1 )$$

where d_{m,U} and d_{m,E} are the vertical deformation and the east-west deformation corresponding to an m-th moment, respectively, a₀, a₁, a₂, a₃, A₁, and A₂ are parameters of a constraint model for the vertical deformation, b₀, b₁, b₂, b₃, B₁, and B₂ are parameters of a constraint model for the east-west deformation, t₀ represents the initial time, namely the acquisition time of the first SAR image, tₘ represents the m-th moment, namely an acquisition time of the m-th SAR image, α_{U} and α_{E} represents thermal expansion deformation coefficients in the vertical direction and the east-west direction, respectively (subsequently, they will be used to exclude non-stress deformation components), and γₘ represents a temperature difference between the acquisition time tₘ of the m-th SAR image and the initial time t₀.

An expression of the second constraint model is as follows:

$$\{ \begin{matrix}\begin{matrix}{d}_{m , K} = {p}_{0} + {p}_{1} ( {t}_{m} - {t}_{0} ) + \frac{1}{2} {{p}_{2} ( {t}_{m} - {t}_{0} )}^{2} + \\ \frac{1}{6} {p}_{3} {( {t}_{m} - {t}_{0} )}^{3} + {H}_{1} sin ( 2 π {t}_{m} / T ) + {H}_{2} cos ( 2 π {t}_{m} / T ) + {α}_{K} {γ}_{m}\end{matrix} \\ \begin{matrix}{d}_{m , T} = {q}_{0} + {q}_{1} ( {t}_{m} - {t}_{0} ) + \frac{1}{2} {{q}_{2} ( {t}_{m} - {t}_{0} )}^{2} + \\ \frac{1}{6} {q}_{3} {( {t}_{m} - {t}_{0} )}^{3} + {I}_{1} sin ( 2 π {t}_{m} / T ) + {I}_{2} cos ( 2 π {t}_{m} / T ) + {α}_{T} {γ}_{m}\end{matrix}\end{matrix} \qquad ( 2 )$$

where d_{m,K} and d_{m,T} are the downslope deformation and the perpendicular-to-downslope deformation corresponding to the m-th moment, respectively, p₀, p₁, p₂, p₃, H₁, and H₂ are parameters of a constraint model for the downslope deformation, q₀, q₁, q₂, q₃, I₁, and I₂ are parameters of a constraint model for the perpendicular-to-downslope deformation, to represents the initial time, namely the acquisition time of the first SAR image, tₘ represents the m-th moment, namely the acquisition time of the m-th SAR image, α_{K} and α_{T} represents thermal expansion deformation coefficients in the downslope direction and the perpendicular-to-downslope direction, respectively (subsequently, they will be used to exclude non-stress deformation components), and γₘ represents the temperature difference between the acquisition time tₘ of the m-th SAR image and the initial time t₀.

In an embodiment, the monitoring model further includes a first observation equation and a second observation equation. A process of inputting the deformation observation of the target landslide in the line-of-sight direction into the monitoring model to obtain the deformation time series of the sliding mass in the vertical direction, the east-west direction, the downslope direction, and the perpendicular-to-downslope direction, at least includes the following steps. The vertical deformation and the east-west deformation are constrained based on the first constraint model to thereby construct the first observation equation with independent constraint conditions respectively for the constraint model for the vertical deformation and the constraint model for the east-west deformation. The downslope deformation and the perpendicular-to-downslope deformation are constrained based on the second constraint model to thereby construct the second observation equation with independent constraint conditions respectively for the constraint model for the downslope deformation and the constraint model for the perpendicular-to-downslope deformation. The time-series deformations of the sliding mass in the vertical direction and the east-west direction are calculated based on the first observation equation. The time-series deformations of the sliding mass in the downslope direction and the perpendicular-to-downslope direction are calculated based on the second observation equation.

In the embodiment, considering inconsistent patterns between the vertical deformation and the east-west deformation, and between the downslope deformation and the perpendicular-downslope deformation, mutually independent constraint models are constructed to reduce mutual interference of models during calculation, and at the same time to make a more accurate fitting based on actual characteristics and data characteristics of deformation in each direction.

Specifically, an expression of a one-dimensional constraint model is as follows:

$${d}_{m , LOS} = {a}_{0} + {a}_{1} ( {t}_{m} - {t}_{0} ) + {{a}_{2} ( {t}_{m} - {t}_{0} )}^{2} + {a}_{3} sin ( 2 π {t}_{m} / T ) + {a}_{4} cos ( 2 π {t}_{m} / T ) \qquad ( 3 )$$

where, d_{m,LOS} represents time-series deformation in the light-of sight direction corresponding to the m-th (m=0, 1, 2, . . . , M) moment after merger of two platforms, and d_{0,LOS}=0; t₀ represents the initial time, namely the acquisition time of the first SAR image, tₘ represents the m-th moment, namely the acquisition time of the m-th SAR image, T represents a period of the sine and cosine functions and is usually taken as 1 year, a₀, a₁, a₂, a₃, and a₄ are model parameters.

A matrix form of a time-series two-dimensional deformation calculation equation set of a point i with a same name under constraint conditions of a single deformation model is as follows:

$$[ \begin{matrix} & & & & & & & & & & & & & & 0 & 0 & 0 & 0 & 0 \\ & & & & & & & & & & & & & & ⋮ & ⋮ & ⋮ & ⋮ & ⋮ \\ & & {G}_{U} & & & & & & & & {G}_{E} & & & & 0 & 0 & 0 & 0 & 0 \\ 0 & 0 & 0 & 0 & 0 & … & 0 & 0 & 0 & 0 & 0 & 0 & … & 0 & - 1 & 0 & 0 & 0 & 0 \\ {u}_{1} & 0 & 0 & 0 & 0 & … & 0 & {e}_{1} & 0 & 0 & 0 & 0 & … & 0 & - 1 & - {c}_{1} & - {c}_{1}^{2} & - {f}_{1} & - {g}_{1} \\ {u}_{1} & {u}_{2} & 0 & 0 & 0 & … & 0 & {e}_{1} & {e}_{2} & 0 & 0 & 0 & … & 0 & - 1 & - {c}_{2} & - {c}_{2}^{2} & - {f}_{2} & - {g}_{2} \\ {u}_{1} & {u}_{2} & {u}_{3} & 0 & 0 & … & 0 & {e}_{1} & {e}_{2} & {e}_{3} & 0 & 0 & … & 0 & - 1 & - {c}_{3} & - {c}_{3}^{2} & - {f}_{3} & - {g}_{3} \\ {u}_{1} & {u}_{2} & {u}_{3} & {u}_{4} & 0 & … & 0 & {e}_{1} & {e}_{2} & {e}_{3} & {e}_{4} & 0 & … & 0 & - 1 & - {c}_{4} & - {c}_{4}^{2} & - {f}_{4} & - {g}_{4} \\ ⋮ & ⋮ & ⋮ & ⋮ & ⋱ & ⋱ & 0 & ⋮ & ⋮ & ⋮ & ⋮ & ⋱ & ⋱ & 0 & ⋮ & ⋮ & ⋮ & ⋮ & ⋮ \\ ⋮ & ⋮ & ⋮ & ⋮ & ⋮ & ⋱ & 0 & ⋮ & ⋮ & ⋮ & ⋮ & ⋮ & ⋱ & 0 & ⋮ & ⋮ & ⋮ & ⋮ & ⋮ \\ {u}_{1} & {u}_{2} & {u}_{3} & {u}_{4} & … & … & {u}_{M} & {e}_{1} & {e}_{2} & {e}_{3} & {e}_{4} & … & … & {e}_{M} & - 1 & - {c}_{M} & - {c}_{M}^{2} & - {f}_{M} & - {g}_{M}\end{matrix} ] \cdot [ \begin{matrix}Δ {d}_{U} \\ Δ {d}_{E} \\ X\end{matrix} ] = \text{} [ \begin{matrix}Δ {d}_{LOS} \\ 0 \\ 0 \\ 0 \\ 0 \\ 0 \\ ⋮ \\ ⋮ \\ 0\end{matrix} ] \qquad ( 4 )$$

where, in a first term on a left side of an equal sign, a part above a solid horizontal line is a coefficient matrix of the time-series two-dimensional deformation calculation equation set, a part below the solid horizontal line is the constraint conditions constructed based on the deformation model, which is divided into three parts by two vertical dashed lines, namely, a projection coefficient matrix from the vertical direction to the line of sight direction, a projection coefficient matrix from the east-west direction to the line-of-sight direction, and a matrix composed of coefficients of elements in parameters X of a constraint model to be estimated. The two vertical dashed lines divide the part above the solid horizontal line and the part below the solid line into three parts respectively, and the three parts multiply with Δd_{U}, Δd_{E}, and X from left to right. In a vector on a right side of the equal sign, a part above the solid horizontal line is deformation observations in the light-of-sight direction corresponding to interferometric pairs from the two platforms, and zero values below the solid horizontal line are virtual observations required for constructing the constraint conditions. G_{U}=Dₘₐₜ·*R_{U}, G_{E}=Dₘₐₜ·*R_{E}, X=[a₀, a₁, a₂, a₃, a₄]^{T}; cₘ=(tₘ−t₀), m=0, 1, 2, . . . , M, fₘ=sin (2πtₘ/T), m=0, 1, 2, . . . , M, gₘ=cos (2πtₘ/T), m=0, 1, 2, . . . , M, uₘ=cos θᵢ, m=0, 1, 2, . . . , M; eₘ=sin θᵢ cos φᵢ, m=0, 1, 2, . . . , M; where θᵢ and φᵢ are an incident angle of a radar wave and a flight azimuth angle of a satellite corresponding to an i-th point with the same name (different ground targets correspond to different angle values).

An expression of the first observation equation based on two-dimensional composite model constraints can be obtained according to the above calculation equation set based on one-dimensional deformation constraints, specifically as follows:

$$[ \begin{matrix} & & & & & & & & & & & & & & 0 & 0 & 0 & 0 & 0 & 0 & 0 & 0 & 0 & 0 & 0 & 0 & 0 & 0 \\ & & & & & & & & & & & & & & ⋮ & ⋮ & ⋮ & ⋮ & ⋮ & ⋮ & ⋮ & ⋮ & ⋮ & ⋮ & ⋮ & ⋮ & ⋮ & ⋮ \\ & & {G}_{U} & & & & & & & & {G}_{E} & & & & 0 & 0 & 0 & 0 & 0 & 0 & 0 & 0 & 0 & 0 & 0 & 0 & 0 & 0 \\ 0 & 0 & 0 & 0 & 0 & … & 0 & 0 & 0 & 0 & 0 & 0 & … & 0 & - 1 & 0 & 0 & 0 & 0 & 0 & 0 & 0 & 0 & 0 & 0 & 0 & 0 & 0 \\ 1 & 0 & 0 & 0 & 0 & … & 0 & 0 & 0 & 0 & 0 & 0 & … & 0 & - 1 & - {c}_{1} & \text{?} & \text{?} & - {f}_{1} & - {g}_{1} & \text{?} & 0 & 0 & 0 & 0 & 0 & 0 & 0 \\ 1 & 1 & 0 & 0 & 0 & … & 0 & 0 & 0 & 0 & 0 & 0 & … & 0 & - 1 & - {c}_{2} & \text{?} & \text{?} & - {f}_{2} & - {g}_{2} & \text{?} & 0 & 0 & 0 & 0 & 0 & 0 & 0 \\ 1 & 1 & 1 & 0 & 0 & … & 0 & 0 & 0 & 0 & 0 & 0 & … & 0 & ⋮ & ⋮ & ⋮ & ⋮ & ⋮ & ⋮ & ⋮ & ⋮ & ⋮ & ⋮ & ⋮ & ⋮ & ⋮ & ⋮ \\ 1 & 1 & 1 & 1 & 0 & … & 0 & 0 & 0 & 0 & 0 & 0 & … & 0 & ⋮ & ⋮ & ⋮ & ⋮ & ⋮ & ⋮ & ⋮ & ⋮ & ⋮ & ⋮ & ⋮ & ⋮ & ⋮ & ⋮ \\ ⋮ & ⋮ & ⋮ & ⋮ & ⋱ & ⋱ & 0 & ⋮ & ⋮ & ⋮ & ⋮ & ⋱ & ⋱ & 0 & ⋮ & ⋮ & ⋮ & ⋮ & ⋮ & ⋮ & ⋮ & ⋮ & ⋮ & ⋮ & ⋮ & ⋮ & ⋮ & ⋮ \\ ⋮ & ⋮ & ⋮ & ⋮ & ⋮ & 1 & 0 & ⋮ & ⋮ & ⋮ & ⋮ & ⋮ & 0 & 0 & - 1 & \text{?} & \text{?} & \text{?} & \text{?} & \text{?} & \text{?} & 0 & 0 & 0 & 0 & 0 & 0 & 0 \\ 1 & 1 & 1 & 1 & 1 & … & 1 & 0 & 0 & 0 & 0 & 0 & … & 0 & - 1 & \text{?} & \text{?} & \text{?} & \text{?} & \text{?} & \text{?} & 0 & 0 & 0 & 0 & 0 & 0 & 0 \\ 0 & 0 & 0 & 0 & 0 & … & 0 & 0 & 0 & 0 & 0 & 0 & … & 0 & 0 & 0 & 0 & 0 & 0 & 0 & 0 & - 1 & 0 & 0 & 0 & 0 & 0 & 0 \\ 0 & 0 & 0 & 0 & 0 & … & 0 & 1 & 0 & 0 & 0 & 0 & … & 0 & 0 & 0 & 0 & 0 & 0 & 0 & 0 & - 1 & - {c}_{1} & \text{?} & \text{?} & \text{?} & \text{?} & \text{?} \\ 0 & 0 & 0 & 0 & 0 & … & 0 & 1 & 1 & 0 & 0 & 0 & … & 0 & 0 & 0 & 0 & 0 & 0 & 0 & 0 & - 1 & - {c}_{2} & \text{?} & \text{?} & \text{?} & \text{?} & \text{?} \\ 0 & 0 & 0 & 0 & 0 & … & 0 & 1 & 1 & 1 & 0 & 0 & … & 0 & 0 & 0 & 0 & 0 & 0 & 0 & 0 & ⋮ & ⋮ & ⋮ & ⋮ & ⋮ & ⋮ & ⋮ \\ 0 & 0 & 0 & 0 & 0 & … & 0 & 1 & 1 & 1 & 1 & 0 & … & 0 & 0 & 0 & 0 & 0 & 0 & 0 & 0 & ⋮ & ⋮ & ⋮ & ⋮ & ⋮ & ⋮ & ⋮ \\ ⋮ & ⋮ & ⋮ & ⋮ & ⋱ & ⋱ & 0 & ⋮ & ⋮ & ⋮ & ⋮ & ⋱ & ⋱ & 0 & 0 & 0 & 0 & 0 & 0 & 0 & 0 & ⋮ & ⋮ & ⋮ & ⋮ & ⋮ & ⋮ & ⋮ \\ ⋮ & ⋮ & ⋮ & ⋮ & ⋮ & 0 & 0 & ⋮ & ⋮ & ⋮ & ⋮ & ⋮ & 1 & 0 & 0 & 0 & 0 & 0 & 0 & 0 & 0 & - 1 & \text{?} & \text{?} & \text{?} & \text{?} & \text{?} & \text{?} \\ 0 & 0 & 0 & 0 & 0 & … & 0 & ⋮ & 1 & 1 & 1 & 1 & 1 & 1 & 0 & 0 & 0 & 0 & 0 & 0 & 0 & - 1 & \text{?} & \text{?} & \text{?} & \text{?} & \text{?} & \text{?}\end{matrix} ] \cdot \text{} [ \begin{matrix}Δ \text{?} \\ Δ \text{?} \\ \text{?} \\ \text{?}\end{matrix} ] = \text{} [ \begin{matrix}Δ {d}_{LOS} \\ 0 \\ 0 \\ 0 \\ ⋮ \\ ⋮ \\ ⋮ \\ 0 \\ 0 \\ 0 \\ 0 \\ 0 \\ 0 \\ ⋮ \\ ⋮ \\ 0 \\ 0\end{matrix} ] \qquad ( 5 )$$

$$\text{?} \text{indicates text missing or illegible when filed}$$

where, G_{U}=Dₘₐₜ·*R_{U}, G_{E}=Dₘₐₜ·*R_{E}, X₁=[a₀, a₁, a₂, a₃, A₁, A₂, α_{U}]^{T}, X₂=[b₀, b₁, b₂, b₃, B₁, B₂, α_{E}]^{T}, X₁ and X₂ are respectively parameters of constraint models for the vertical deformation and the east-west deformation; cₘ=(tₘ−t₀), m=0, 1, 2, . . . , M, fₘ=sin (2πtₘ/T), m=0, 1, 2, . . . , M; gₘ=cos (2πtₘ/T), m=0, 1, 2, . . . , M.

For the landslide, the vertical deformation and the east-west deformation are apparent reflections of the downslope deformation and the perpendicular-to-downslope deformation. Merely obtaining the time-series deformations of the landslide in the vertical direction and the east-west direction is insufficient to characterize movement characteristics of the landslide. In contrast, the downslope deformation and the perpendicular-to-downslope deformation are most direct indicators for representing dynamic changes of the landslide. Techniques in the art can only obtain deformation rates of the landslide in the downslope direction and the perpendicular-to-downslope direction, but cannot acquire deformation time series in the downslope direction and the perpendicular-to-downslope direction. As a result, they cannot support analysis of evolution patterns of the landslide deformation or dynamic risk assessment. The time-series InSAR method provided by the disclosure starts with observation geometry of ascending and descending SAR satellites, and three-dimensional spatial geometry of a ground surface and its relative relationship with sliding surface geometry of the landslide, and constructs a solution for time-series two-dimensional deformations in the downslope direction and the perpendicular-to-downslope direction.

As illustrated in FIG. 2, the sliding mass moves downward along a sliding surface. A sliding surface coordinate system is composed of three orthogonal unit vectors, including a downslope axis, a perpendicular-to-downslope axis, and a normal axis, denoted as OK, OT, and OI, respectively. A direction indicated by the downslope axis is a slope direction of the sliding surface, and a direction indicated by the normal axis is a normal direction of the sliding surface. Movement downward along the downslope axis is considered positive, movement to right along the perpendicular-to-downslope axis is considered positive, and movement outward from the sliding surface along the normal axis is considered positive. Deformation of the sliding mass can also be represented by a “north-east-high” coordinate system composed of three directions: a north-south direction (ON), the east-west direction (OE), and the vertical direction (OH), so a geometric relationship between the two coordinate systems can be constructed by a slope gradient and a slope direction.

FIG. 3 illustrates the geometric relationship between the sliding surface coordinate system and the “north-east-high” coordinate system. D_{K}, D_{T}, and D_{I} represent time-series deformations along the OK, OT, and OI axes of the sliding surface coordinate system (i.e., the downslope deformation, the perpendicular-to-downslope deformation, and normal deformation), respectively. D_{N}, D_{E}, and D_{H} represent time-series deformations along the OE, ON, OH axes of the “north-east-high” coordinate system, respectively. α and β represent the slope gradient and the slope direction of the sliding surface, respectively. It can be known from the geometric relationship between the sliding surface coordinate system and the “north-east-high” coordinate system, deformation projections of D_{K} and D_{I} exist on both the horizontal plane and the vertical direction. Since the downslope axis OK and the normal axis OI are in a same vertical plane, the deformation projections of D_{K} and D_{I} in the horizontal plane should overlap. The D_{T} is perpendicular to a plane OIK, therefore deformation projection of D_{T} in the vertical direction is zero. D_{T} lies in the horizontal plane, therefore the deformation projection of D_{T} exists in the east-west direction and the north-south direction. Based on this, a projection relationship matrix of the deformation between the sliding surface coordinate system and the “north-east-height” coordinate system can be obtained, specifically as follows:

$$[ \begin{matrix}{D}_{E} \\ {D}_{N} \\ {D}_{H}\end{matrix} ] = [ \begin{matrix}cos αsin β & - cos β & sin αsin β \\ cos αcos β & sin β & sin αcos β \\ - sin α & 0 & cos α\end{matrix} ] [ \begin{matrix}{D}_{E} \\ {D}_{T} \\ {D}_{I}\end{matrix} ] . \qquad ( 6 )$$

Displacement along a direction facing toward a satellite is defined as positive, and displacement along a direction facing away from the satellite is defined as negative. According to radar satellite imaging geometry, a deformation of the ground surface D_{Los} along the line-of-sight direction is actually a sum of projections of a deformation of the ground surface along the east-west direction D_{E}, a deformation of the ground surface along the north-south direction D_{N}, and a deformation of the ground surface along the vertical (upward or downward) direction D_{H} onto the line-of-sight direction, as expressed in the following equation:

$${D}_{LOS} = [ \begin{matrix}cos θ & sin θsin φ & - sin θ cos φ\end{matrix} ] [ \begin{matrix}{D}_{H} \\ {D}_{N} \\ {D}_{E}\end{matrix} ] \qquad ( 7 )$$

where θ represents the incident angle of the radar wave, and φ represents a heading angle of the satellite.

Therefore, projection relationship matrix of the deformation between the sliding surface coordinate system and the light-of-sight direction of a radar satellite can be obtained:

$${D}_{LOS} = [ \begin{matrix}a & b & c\end{matrix} ] [ \begin{matrix}{D}_{K} \\ {D}_{T} \\ {D}_{I}\end{matrix} ] \qquad ( 8 )$$

$$a = cos θcos αsin β + sin θ sin φ cos α cos β + sin θ cos φ sin α \\ b = - cos θ cos β + sin θ sin φ sin β \\ c = cos θ sin α sin β + sin θ sin φ sin α cos β - sin θ cos φcos α \qquad ( 9 )$$

where, a, b, and c are projection coefficients of the deformation along the downslope direction, the perpendicular-to-downslope direction, and the normal direction, respectively.

In a natural environment, the sliding mass generally moves downward along the sliding surface under action of gravity. In absence of significant external forces, the deformation in the normal direction of the sliding surface is much smaller compared to deformations in other directions; therefore, the time-series deformation along the normal direction D_{I} can be neglected. Based on this, the aforementioned projection relationship matrix can be simplified as an estimation model of two-dimensional downslope deformation and perpendicular-to-downslope deformation in the sliding surface, specifically expressed as follows:

$${D}_{LOS} = [ \begin{matrix}a & b\end{matrix} ] [ \begin{matrix}{D}_{K} \\ {D}_{T}\end{matrix} ] \qquad ( 10 )$$

$$a = cos θcos αsin β + sin θ sin φ cos α cos β + sin θ cos φ sin α \\ b = - cos θ cos β + sin θ sin φ sin β \qquad ( 11 )$$

A modeling process for the deformation time series in the downslope direction and the perpendicular-to-downslope direction is similar to modeling and solving for two-dimensional deformation time series in the vertical direction and the east-west direction, which still involves using average downslope deformation and perpendicular-to-downslope deformation over a time interval between two adjacent SAR images, or deformation increments between two moments as parameters to be estimated in the modeling and solving process. The “two adjacent SAR images” described herein refer to two SAR images that are temporally consecutive in a sequence of M+1 SAR images after combining the two platforms and arranging the M+1 SAR images in chronological order. Still taking the i-th point with the same name as an example, a fundamental observation equation set for solving the time-series two-dimensional deformation is constructed based on the estimation model of two-dimensional downslope deformation and perpendicular-to-downslope deformation within the sliding surface, expressed in matrix form as:

$$[ {D}_{mat} \cdot * {R}_{K} {D}_{mat} \cdot * {R}_{T} ] \cdot [ \begin{matrix}Δ {d}_{K} \\ Δ {d}_{T}\end{matrix} ] = Δ {d}_{LOS} \qquad ( 12 )$$

where Δd_{Los} is a column vector of Y-order light-of-sight deformation observations constructed from all Δd_{i,k,LOS}(if gⱼ), which is arranged in an order of different platform numbers k; Δd_{K} and Δd_{T} are M-order column vectors composed of the time-series deformations in the downslope direction and the perpendicular-to-downslope direction in the time interval between two adjacent SAR images in the M+1 SAR images, respectively; Dₘₐₜ is a Y×M-order design matrix composed of 0s and 1s, in which 1 corresponds to a time interval between adjacent SAR images contained within a time span of a specific interferogram, and all other elements are 0; R_{K}=aₖ, R_{T}=bₖ (k=1,2) are Z×M-order matrices composed of projection coefficients of different platforms from the downslope direction and the perpendicular-to-downslope direction to the light-of-sight direction, respectively; aₖ and bₖ represent conversion parameters corresponding to a k-th platform (see formula (11)), which are arranged in the order of different platform numbers k; “.*” represents multiplication of elements at corresponding positions in two matrices; “.” represents matrix multiplication. Assuming that the equation set (12) is solvable, when Δd_{K} and Δd_{T} are obtained, the time-series deformations in the downslope direction and the perpendicular-to-downslope direction can be obtained by integrating internal elements of Δd_{K} and Δd_{T} in the time dimension. However, due to incomplete coincidence of acquisition times of SAR images of different platforms, the equation set (12) is rank-deficient and cannot be solved normally. Therefore, the second constraint condition is constructed for the time-series deformations in the downslope direction and the perpendicular-to-downslope direction. Combining equations (2), (11), and (12) yields the second observation equation, specifically as follows:

$$[ \begin{matrix} & & & & & & & & & & & & & & 0 & 0 & 0 & 0 & 0 & 0 & 0 & 0 & 0 & 0 & 0 & 0 & 0 & 0 \\ & & & & & & & & & & & & & & ⋮ & ⋮ & ⋮ & ⋮ & ⋮ & ⋮ & ⋮ & ⋮ & ⋮ & ⋮ & ⋮ & ⋮ & ⋮ & ⋮ \\ & & {G}_{U} & & & & & & & & {G}_{E} & & & & 0 & 0 & 0 & 0 & 0 & 0 & 0 & 0 & 0 & 0 & 0 & 0 & 0 & 0 \\ 0 & 0 & 0 & 0 & 0 & … & 0 & 0 & 0 & 0 & 0 & 0 & … & 0 & - 1 & 0 & 0 & 0 & 0 & 0 & 0 & 0 & 0 & 0 & 0 & 0 & 0 & 0 \\ 1 & 0 & 0 & 0 & 0 & … & 0 & 0 & 0 & 0 & 0 & 0 & … & 0 & - 1 & - {c}_{1} & \text{?} & \text{?} & - {f}_{1} & - {g}_{1} & \text{?} & 0 & 0 & 0 & 0 & 0 & 0 & 0 \\ 1 & 1 & 0 & 0 & 0 & … & 0 & 0 & 0 & 0 & 0 & 0 & … & 0 & - 1 & - {c}_{2} & \text{?} & \text{?} & - {f}_{2} & - {g}_{2} & \text{?} & 0 & 0 & 0 & 0 & 0 & 0 & 0 \\ 1 & 1 & 1 & 0 & 0 & … & 0 & 0 & 0 & 0 & 0 & 0 & … & 0 & ⋮ & ⋮ & ⋮ & ⋮ & ⋮ & ⋮ & ⋮ & ⋮ & ⋮ & ⋮ & ⋮ & ⋮ & ⋮ & ⋮ \\ 1 & 1 & 1 & 1 & 0 & … & 0 & 0 & 0 & 0 & 0 & 0 & … & 0 & ⋮ & ⋮ & ⋮ & ⋮ & ⋮ & ⋮ & ⋮ & ⋮ & ⋮ & ⋮ & ⋮ & ⋮ & ⋮ & ⋮ \\ ⋮ & ⋮ & ⋮ & ⋮ & ⋱ & ⋱ & 0 & ⋮ & ⋮ & ⋮ & ⋮ & ⋱ & ⋱ & 0 & ⋮ & ⋮ & ⋮ & ⋮ & ⋮ & ⋮ & ⋮ & ⋮ & ⋮ & ⋮ & ⋮ & ⋮ & ⋮ & ⋮ \\ ⋮ & ⋮ & ⋮ & ⋮ & ⋮ & 1 & 0 & ⋮ & ⋮ & ⋮ & ⋮ & ⋮ & 0 & 0 & - 1 & \text{?} & \text{?} & \text{?} & \text{?} & \text{?} & \text{?} & 0 & 0 & 0 & 0 & 0 & 0 & 0 \\ 1 & 1 & 1 & 1 & 1 & … & 1 & 0 & 0 & 0 & 0 & 0 & … & 0 & - 1 & \text{?} & \text{?} & \text{?} & \text{?} & \text{?} & \text{?} & 0 & 0 & 0 & 0 & 0 & 0 & 0 \\ 0 & 0 & 0 & 0 & 0 & … & 0 & 0 & 0 & 0 & 0 & 0 & … & 0 & 0 & 0 & 0 & 0 & 0 & 0 & 0 & - 1 & 0 & 0 & 0 & 0 & 0 & 0 \\ 0 & 0 & 0 & 0 & 0 & … & 0 & 1 & 0 & 0 & 0 & 0 & … & 0 & 0 & 0 & 0 & 0 & 0 & 0 & 0 & - 1 & - {c}_{1} & \text{?} & \text{?} & \text{?} & \text{?} & \text{?} \\ 0 & 0 & 0 & 0 & 0 & … & 0 & 1 & 1 & 0 & 0 & 0 & … & 0 & 0 & 0 & 0 & 0 & 0 & 0 & 0 & - 1 & - {c}_{2} & \text{?} & \text{?} & \text{?} & \text{?} & \text{?} \\ 0 & 0 & 0 & 0 & 0 & … & 0 & 1 & 1 & 1 & 0 & 0 & … & 0 & 0 & 0 & 0 & 0 & 0 & 0 & 0 & ⋮ & ⋮ & ⋮ & ⋮ & ⋮ & ⋮ & ⋮ \\ 0 & 0 & 0 & 0 & 0 & … & 0 & 1 & 1 & 1 & 1 & 0 & … & 0 & 0 & 0 & 0 & 0 & 0 & 0 & 0 & ⋮ & ⋮ & ⋮ & ⋮ & ⋮ & ⋮ & ⋮ \\ ⋮ & ⋮ & ⋮ & ⋮ & ⋱ & ⋱ & 0 & ⋮ & ⋮ & ⋮ & ⋮ & ⋱ & ⋱ & 0 & 0 & 0 & 0 & 0 & 0 & 0 & 0 & ⋮ & ⋮ & ⋮ & ⋮ & ⋮ & ⋮ & ⋮ \\ ⋮ & ⋮ & ⋮ & ⋮ & ⋮ & 0 & 0 & ⋮ & ⋮ & ⋮ & ⋮ & ⋮ & 1 & 0 & 0 & 0 & 0 & 0 & 0 & 0 & 0 & - 1 & \text{?} & \text{?} & \text{?} & \text{?} & \text{?} & \text{?} \\ 0 & 0 & 0 & 0 & 0 & … & 0 & ⋮ & 1 & 1 & 1 & 1 & 1 & 1 & 0 & 0 & 0 & 0 & 0 & 0 & 0 & - 1 & \text{?} & \text{?} & \text{?} & \text{?} & \text{?} & \text{?}\end{matrix} ] \cdot \text{} [ \begin{matrix}Δ \text{?} \\ Δ \text{?} \\ \text{?} \\ \text{?}\end{matrix} ] = \text{} [ \begin{matrix}Δ {d}_{LOS} \\ 0 \\ 0 \\ 0 \\ ⋮ \\ ⋮ \\ ⋮ \\ 0 \\ 0 \\ 0 \\ 0 \\ 0 \\ 0 \\ ⋮ \\ ⋮ \\ 0 \\ 0\end{matrix} ] \qquad ( 13 )$$

$$\text{?} \text{indicates text missing or illegible when filed}$$

where, G_{K}=Dₘₐₜ·*R_{K}; G_{T}=Dₘₐₜ·*R_{T}; Y₁=[p₀, p₁, p₂, p₃, H₁, H₂, α_{K}]_{T}, Y₂=[q₀, q₁, q₂, q₃, I₁, I₂, α_{T}]^{T}, Y₁ and Y₂ respectively are parameters of constraint models for the downslope deformation and the perpendicular-to-downslope deformation; cₘ=(tₘ−t₀), m=0, 1, 2, . . . , M, fₘ=sin (2πtₘ/T), m=0, 1, 2, . . . , M; gₘ=cos (2πtₘ/T), m=0, 1, 2, . . . , M.

In an embodiment, the progress of inputting the deformation observation of the target landslide in the line-of-sight direction into the monitoring model to obtain the deformation time series of the sliding mass in the vertical direction, the east-west direction, the downslope direction, and the perpendicular-to-downslope direction further includes the following steps. The deformation time series in the vertical direction and the east-west direction are obtained through integration of the time dimension based on the time-series deformations in the vertical direction and the east-west direction. The deformation time series in the downslope direction and the perpendicular-to-downslope direction are obtained through the integration of the time dimension based on the time-series deformations in the downslope direction and the perpendicular-to-downslope direction. Weights are assigned to different platforms through a variance component estimation method. The deformation time series are refined step by step through an iteratively reweighted least squares.

In the embodiments, since the vertical deformation and the east-west deformation are respectively constrained, it is not necessary to project them into the line of sight direction when constructing the constraint conditions, so a problem of angle selection of uₘ=cos θᵢ and eₘ=sin θᵢ cos φᵢ in equation set (4) can be avoided, and uₘ and eₘ can be directly replaced with a constant 1. Subsequently, the time-series deformations in the vertical direction and the east-west direction at a time interval between acquisition times of adjacent SAR images can be calculated through a least square method or a singular value decomposition (SVD) method, and the deformation time series in the two directions can be obtained through integration of the time dimension. Similarly, deformation time series in the downslope direction and the perpendicular-to-downslope direction can be obtained based on the aforementioned method.

It should be noted that, accuracy levels of deformation observations in the light-of-sight direction of different platforms are different. Therefore, firstly, pre-adjustment is performed using a noise standard deviation of a differential interferogram of each platform as an initial weight (a priori estimated weight matrix). Observation residuals obtained after the pre-adjustment are used to estimate variances of observations of different platforms. The weights are re-assigned based on estimation values of the variances to improve initial values of the priori estimated weight matrix during a first adjustment to thereby obtain a re-determined weight matrix. Adjustment is performed again based on the re-determined weight matrix. This process is repeated until the variances of observations of different platforms tend to be consistent, thereby obtaining weighted adjustment estimation values for the deformation time series in the vertical direction and the east-west direction.

To sum up, technical solutions of the disclosure have been described with reference to specific embodiments illustrated in the attached drawings. However, those skilled in the art can easily understand that the scope of protection of the disclosure is apparently not limited to these specific embodiments. Those skilled in the art can make equivalent changes or substitutions to original technical features without departing from principles of the disclosure, and technical solutions after these changes or substitutions shall fall within the scope of protection of the disclosure.

What is claimed is:

1. A time-series interferometric synthetic aperture radar (InSAR) method for monitoring multi-dimensional deformation of a landslide, comprising the following steps:
obtaining a deformation observation of a target landslide in a line-of-sight direction; and
inputting the deformation observation of the target landslide in the line-of-sight direction into a monitoring model to obtain deformation time series of a sliding mass in a vertical direction, an east-west direction, a downslope direction, and a perpendicular-to-downslope direction, wherein the monitoring model at least comprises a fractal composite structure deformation constraint model; constraining vertical deformation and east-west deformation based on a first constraint condition constructed by the fractal composite structure deformation constraint model; and constraining downslope deformation and perpendicular-to-downslope deformation based on a second constraint condition constructed by the fractal composite structure deformation constraint model;
wherein the fractal composite structure deformation constraint model comprises a first constraint model and a second constraint model, the first constraint model is a constraint model for time-series deformations in the vertical direction and the east-west direction, and the second constraint model is a constraint model for time-series deformations in the downslope direction and the perpendicular-to-downslope direction;
wherein the time-series InSAR method further comprises: constructing the fractal composite structure deformation constraint model, which at least comprises: constructing the first constraint model and the second constraint model by fully combining mathematical models of surface deformations in different types of regions, specifically comprising the following steps:
obtaining first parameters of the fractal composite structure deformation constraint model, wherein the first parameters comprise: the vertical deformation and the east-west deformation corresponding to an m-th moment, parameters of a constraint model for the vertical deformation, parameters of a constraint model for the east-west deformation, an acquisition time of a first synthetic aperture radar (SAR) image, an acquisition time of an m-th SAR image, thermal expansion deformation coefficients in the vertical direction and the east-west direction, and a temperature difference between the acquisition time of the m-th SAR image and an initial time; and constructing the first constraint model based on the first parameters:
$$\{ \begin{matrix}\begin{matrix}{d}_{m , U} = {a}_{0} + {a}_{1} ( {t}_{m} - {t}_{0} ) + \frac{1}{2} {{a}_{2} ( {t}_{m} - {t}_{0} )}^{2} + \\ \frac{1}{6} {a}_{3} {( {t}_{m} - {t}_{0} )}^{3} + {A}_{1} sin ( 2 π {t}_{m} / T ) + {A}_{2} cos ( 2 π {t}_{m} / T ) + {α}_{U} {γ}_{m}\end{matrix} \\ \begin{matrix}{d}_{m , E} = {b}_{0} + {b}_{1} ( {t}_{m} - {t}_{0} ) + \frac{1}{2} {{b}_{2} ( {t}_{m} - {t}_{0} )}^{2} + \\ \frac{1}{6} {b}_{3} {( {t}_{m} - {t}_{0} )}^{3} + {B}_{1} sin ( 2 π {t}_{m} / T ) + {B}_{2} cos ( 2 π {t}_{m} / T ) + {α}_{E} {γ}_{m}\end{matrix}\end{matrix}$$
where d_{m,U} and d_{m,E} are the vertical deformation and the east-west deformation corresponding to the m-th moment, respectively, a₀, a₁, a₂, a₃, A₁, and A₂ are the parameters of the constraint model for the vertical deformation, b₀, b₁, b₂, b₃, B₁, and B₂ are the parameters of the constraint model for the east-west deformation, t₀ represents the initial time, namely the acquisition time of the first SAR image, tₘ represents the m-th moment, namely the acquisition time of the m-th SAR image, α_{U} and α_{E} represents the thermal expansion deformation coefficients in the vertical direction and the east-west direction, respectively, and γₘ represents the temperature difference between the acquisition time tₘ of the m-th SAR image and the initial time t₀; and
obtaining second parameters of the fractal composite structure deformation constraint model, wherein the second parameters comprise: the downslope deformation and the perpendicular-to-downslope deformation corresponding to the m-th moment, parameters of a constraint model for the downslope deformation, parameters of a constraint model for the perpendicular-to-downslope deformation, the acquisition time of the first SAR image, the acquisition time of the m-th SAR image, thermal expansion deformation coefficients in the downslope direction and the perpendicular-to-downslope direction, and the temperature difference between the acquisition time of the m-th SAR image and the initial time; and constructing the second constraint model based on the second parameters:
$$\{ \begin{matrix}\begin{matrix}{d}_{m , K} = {p}_{0} + {p}_{1} ( {t}_{m} - {t}_{0} ) + \frac{1}{2} {{p}_{2} ( {t}_{m} - {t}_{0} )}^{2} + \\ \frac{1}{6} {p}_{3} {( {t}_{m} - {t}_{0} )}^{3} + {H}_{1} sin ( 2 π {t}_{m} / T ) + {H}_{2} cos ( 2 π {t}_{m} / T ) + {α}_{K} {γ}_{m}\end{matrix} \\ \begin{matrix}{d}_{m , T} = {q}_{0} + {q}_{1} ( {t}_{m} - {t}_{0} ) + \frac{1}{2} {{q}_{2} ( {t}_{m} - {t}_{0} )}^{2} + \\ \frac{1}{6} {q}_{3} {( {t}_{m} - {t}_{0} )}^{3} + {I}_{1} sin ( 2 π {t}_{m} / T ) + {I}_{2} cos ( 2 π {t}_{m} / T ) + {α}_{T} {γ}_{m}\end{matrix}\end{matrix}$$
where d_{m,K} and d_{m,T} are the downslope deformation and the perpendicular-to-downslope deformation corresponding to the m-th moment, respectively, p₀, p₁, p₂, p₃, H₁, and H₂ are the parameters of the constraint model for the downslope deformation, q₀, q₁, q₂, q₃, I₁, and I₂ are the parameters of the constraint model for the perpendicular-to-downslope deformation, t₀ represents the initial time, namely the acquisition time of the first SAR image, tₘ represents the m-th moment, namely the acquisition time of the m-th SAR image, α_{K} and α_{T} represents the thermal expansion deformation coefficients in the downslope direction and the perpendicular-to-downslope direction, respectively, and γₘ represents the temperature difference between the acquisition time tₘ of the m-th SAR image and the initial time t₀.

2. The time-series InSAR method as claimed in claim 1, wherein the monitoring model further comprises a first observation equation and a second observation equation, and the inputting the deformation observation of the target landslide in the line-of-sight direction into a monitoring model to obtain deformation time series of the sliding mass in a vertical direction, an east-west direction, a downslope direction, and a perpendicular-to-downslope direction at least comprises the following steps:
constraining the vertical deformation and the east-west deformation based on the first constraint model to thereby construct the first observation equation with independent constraint conditions respectively for the constraint model for the vertical deformation and the constraint model for the east-west deformation;
constraining the downslope deformation and the perpendicular-to-downslope deformation based on the second constraint model to thereby construct the second observation equation with independent constraint conditions respectively for the constraint model for the downslope deformation and the constraint model for the perpendicular-to-downslope deformation;
calculating the time-series deformations of the sliding mass in the vertical direction and the east-west direction based on the first observation equation; and
calculating the time-series deformations of the sliding mass in the downslope direction and the perpendicular-to-downslope direction based on the second observation equation.

3. The time-series InSAR method as claimed in claim 2, wherein the inputting the deformation observation of the target landslide in the line-of-sight direction into a monitoring model to obtain deformation time series of the sliding mass in a vertical direction, an east-west direction, a downslope direction, and a perpendicular-to-downslope direction, further comprises the following steps:
obtaining the deformation time series in the vertical direction and the east-west direction through integration of a time dimension based on the time-series deformations in the vertical direction and the east-west direction;
obtaining the deformation time series in the downslope direction and the perpendicular-to-downslope direction through the integration of the time dimension based on the time-series deformations in the downslope direction and the perpendicular-to-downslope direction; and
assigning weights to different platforms through a variance component estimation method, and refining the deformation time series step by step through an iteratively reweighted least squares.
